(19) United States
(12) Patent Application Publication
(10) Pub. No.: US 2002/0169516 A1
(43) Pub. Date: Nov. 14, 2002

(54) Method of controlling an electrochemical machining process

(76) Inventors: Maarten Brussee, Drachten (DE); Nasich Z. Gimaev, Ufa (RU); Aleksandr N. Zajcev, Ufa (RU); Aleksandr L. Belogorskij, Ufa (RU); Igor L. Agafonov, Ufa (RU); Vladimir Pavlovich Zhitnikov, Ufa (RU); Viktor N. Kucenko, Ufa (RU); Rafail R. Muchutdinov, Ufa (RU)

Correspondence Address: Corporate Patent Counsel, Philips Electronics North America Corporation, 580 White Plains Road, Tarrytown, NY, 10591, US

(21) Appl. No.: 10/018,618

(22) PCT Filed: Apr. 10, 2001
(86) PCT No.: PCT/EP01/04100

(30) Foreign Application Priority Data
Apr. 18, 2000 (EP) 00201377.9

(51) Int. Cl. G06F 19/00

(52) U.S. Cl. 700/162

(57) ABSTRACT

A method of controlling a process of electrochemically machining an electrically conductive workpiece employing the spectral composition of the measured voltage within a predetermined measuring period such as induced by an applied current between the electrically conductive workpiece and an electrode tool. A process of electrochemically machining employing a material removing step with electric current supplied continuously and an a workpiece shaping step with electric current supplied intermittently. An advantageous embodiment employs extreme short pulses.

### FIELD OF THE INVENTION

The invention relates to a method of controlling a process of electrochemically machining an electrically conductive workpiece as recited in the preamble of claim 1 as well as to a method of electrochemically machining as recited in the preamble of claim 30. The invention further relates to an arrangement for a performing a method of controlling a process of electrochemically machining as recited in the preamble of claim 39 as well as to an arrangement of electrochemically machining as recited in the preamble of claim 68.

### BACKGROUND OF THE INVENTION

Electrochemically machining is a process in which an electrically conductive workpiece is dissolved at the location of an electrode while electrolyte and electric current is supplied. For this purpose, the electrode is brought in proximity of the workpiece and, while electrolyte is fed into the gap between the workpiece and the electrode, a current is passed through the workpiece and the electrode via the electrolyte, the workpiece being positive with respect to the electrode. The current may be supplied in the form of a constant current while maintaining a sufficient gap to replenish the electrolyte simultaneously. This method allows a high rate of removal of dissolved material. The current may also be supplied in the form of pulses having specific amplitude and duration, the electrolyte being replenished in the interval between the machining pulses. During replenishing the gap between the workpiece and the electrode is then made larger than during machining. The small gap during machining allows a higher machining accuracy. During application of the current, the electrode and the workpiece are moved towards each other with a given feed rate, as a result of which the electrode forms a cavity or eventually a hole in the shape of the workpiece, the shape of this cavity or hole corresponding to the shape of the electrode. This process can be used, for example, for making intricate cavities or holes in hard metals or alloys therefrom.

However, in practice unwanted process conditions may arise that may degrade the normal machining operation. This may due for instance due to the generation of spark discharges that may occur within the gap. Such spark discharges may give rise to damages to the electrode and the workpiece. Another undesired process condition is the presence of gas-filled bubbles or cavities within the machining gap, causing non-conducting regions in the electrolyte. This may lead to an undesired an undefined surface roughness of the workpiece. These gas-filled bubbles may rise owing to a temperature increase or pressure drop along the flow channel. If the growth is caused by temperature increase, due to for example the passage of current, boiling occurs. If the growth is due to pressure reduction, cavitation is said to have occurred. Another undesired process condition is called choking, which is induced by a maximum in mass flow-rate as determined by the smallest area of the gap. A further undesired process condition is the occurrence of a passivating or a non-conductive layer on the workpiece surface.

To avoid such undesired process conditions it is known, from for instance from the International Patent Publication numbered WO 99/34949, document D1 in the list of referred documents that can be found at the end of this description, to measure with antenna means high frequent electromagnetic waves originated from the gap. These are believed to be indicative of so-called partial discharges which are believed to be precursors of a spark discharge. However, measurement of electromagnetic waves is prone to disturbances present in an industrial environment. Also no information with respect to the occurrence of other undesired process conditions as mentioned above is being derived from this information.

From the International Patent Publication numbered WO 97/03781, document D2 in the list of referred documents that can be found at the end of this description, it is known to analyze the waveform induced by the applied current to find the optimum limits for applying pulses of opposite polarity to remove passivation layers. To this end, during a test preceding the machining of the workpiece, the amplitude of the pulses is varied and the optimum limits are derived from the resulting measured parameters, such as the occurrence of a global minimum in the voltage across the gap. However, this test does enable monitoring the occurrence of passivation, let alone during machining itself. Further, if the process conditions change significantly, such as the parameters of the applied current or the electrolyte flow, the test must be repeated.

### OBJECT AND SUMMARY OF THE INVENTION

In consequence, amongst other things, it is an object of the invention to obviate above-mentioned disadvantages. In particular an object of the invention is obtaining a method of controlling a process of electrochemically machining, which allows to monitor one or more process conditions and to adjust the one or more process parameters in order to avoid undesired process conditions, especially while maintaining a constant gap width. According to one of its aspects a method according to the invention is characterized as recited in the characterizing part of claim 1.

Varying process conditions give rise to a change of a measured voltage present for instance across a gap between the electrode and the workpiece. By choosing the measuring period such that a change can be detected within this measuring period, the change as a function of time or shortly the form function defining the type of change within the measuring period can be distinguished. This form function can be decomposed in to its constituent frequency components or frequency spectrum. By employing the information present in this frequency spectrum, indicators indicative of several process conditions, such as for example those mentioned above, can be obtained during the process of machining. It is found that the occurrence of a first process condition influences only a specific part of the spectrum, while a second process condition influences either these part in another way or influences another part. As the information may be obtained continuously, the process may be continuously controlled in response thereto.

More specifically, it has found to be advantageous to employ the amplitudes of the frequency components of the frequency spectrum, according the method of claim 2.

A next advantageous method is to use a harmonic frequency of the waveform according to the method of claim 3. Harmonic frequencies are hereby being defined as an integer multiple of the elementary frequency as determined by the length of the measuring period. Especially the lowest harmonic frequencies appear to be useful in defining process conditions.

Decomposing the form function according to a Fourier series, by a well known Fourier transformation, according to the method of claim 4, has been found useful as a practical mathematical embodiment. Although a form function may be decomposed in several elementary functions, each with a specific frequency, trigonometric functions such as sine and cosine appear to be most useful.

Further it is noted that a conversion of the measured voltage from the time domain to the frequency domain, such as is done by the above-mentioned Fourier transformation, is not the only method to obtain the spectral composition. The spectral information may equally be obtained by performing an autocorrelation in the time domain or by employing suitable frequency band filtering.

A further advantageous method employs only the signs of the Fourier coefficients, according to the method of claim 5. Absolute values may vary in a high degree, while signs, and especially the relative signs, are found to be a more stable indicator of process conditions.

It has been found that a first process condition of relatively low current density, may be assigned to the absence of Fourier coefficients, according to the method of claim 6. A next process condition indicating the presence of gas-filled cavities in the electrolyte, is assigned to Fourier coefficients with alternating signs, according to the method of claim 7.

A further process condition indicating a high current density, may be assigned to the presence of number of Fourier coefficients with equal signs, according to the method of claim 8.

Another advantageous method is obtained by taking into account frequencies above a certain value, and monitoring only a change therein, according to the method of claim 9. This is found to be indicative of approaching a process condition susceptible of electric discharges in the gap. It has been found particular useful to monitor the running average of the corresponding amplitudes, according to the method of claim 10.

It has been found that several process control parameters may be adjusted, in response to the occurrence of changing process situations, to avoid undesired process conditions. In particular changing the duration of a current that is being applied, according to the method of claim 11, has found to be useful. Applying the current intermittently, has the effect of reducing heating the electrolyte and therefore changing a process situation of boiling or cavitating.

A particular advantageous method is obtained when, during applying current intermittently, the electrode and the workpiece are moved relatively to each other in an oscillatory harmonic manner or in repeated non-harmonic manner, according to the method of claim 12. This allows increasing the electrolyte pressure in the gap when current is applied. This consequently counters the generation of bubbles in the electrolyte.

Applying a sequence of current pulses when a small distance between electrode and workpiece is present, according to the method of claim 13, has the advantage of further countering the generation of bubbles.

An undesired process condition is characterized by the generation of a passivation layer on the workpiece, such as an oxide layer which forms a barrier between the workpiece and the electrolyte. An advantageous method is then obtained by applying current pulses of an opposite polarity according to method of claim 14. This causes, as is known from document D2 in the list of referred references, the dissolving of the passivation layer.

A further undesired process situation may be characterized by a lack of machining accuracy. A useful process control parameter to improve a machining accuracy is the addition of passivation pulses according to the method of claim 15.

A next undesired process condition may arise due to a deposition of contaminating materials on the electrode. This leads to inaccurate machining as the distance between the electrode and workpiece may change in an undefined manner, either local or global. Especially in case of electrolyte which has been used for a long time, a deposition of dissolved metal ions of the dissolved workpiece may occur as black layer along the total area of the electrode tool. This is called plating and may effect the geometrical dimensions. Another contamination is deposition of a hydroxide layer near the electrolyte outflow opening within the gap. This does not only effect the geometrical dimension but also the flow rate of the electrolyte. An advantageous process parameter is then the application of electrode cleaning pulses according to the method of claim 16.

A special next embodiment is obtained in a method where the workpiece and the electrode are brought in contact with each other prior to machining in order to calibrate the mutual position. By applying the electrode cleaning pulses just before this action, according to the method of claim 17, an accurate calibration is obtained.

In a method wherein the electrode and the workpiece are moved relatively to each other in a repeated movement and the current pulses are applied when the distance between both is small, the machining accuracy may be high, due to the short distance allowable, but the productivity low, due to a slow flow of electrolyte. A useful process control parameter to adjust is the duration of the pulse periods, according to the method of claim 18. It has been found that decreasing the pulse period, may increase the amount of current which can be applied.

An advantageous value of the reduced pulse period is obtained according to the method of claim 19. The time needed for generation of nuclei preceding the formation of gas bubbles, such as for example hydrogen gas, is a practical criterion for determining the reduced pulse period. This is useful when higher current densities are being employed, normally leading to formation of gas-filled bubbles. With such extreme short pulses no time is left for formation of bubbles.

Although specific values may depend on specific circumstances, a first embodiment of the method employs values according to the method of claim 20.

An important characteristic of such extreme short pulses is the steep pulse forefront, which should have values according to the method of claim 21.

In a process where sequences of intermittently applied electric current pulses are being applied, pauses between the pulses should preferably be chosen according to the method of claim 22, with specifically values according to the method of claim 23.

In a process wherein the electrode and the workpiece are moved relatively to each other in an oscillatory movement and the current is being supplied intermittently when the distance between both is small, a further advantageous process control parameter is the relative phase shift between the movement and the start of applying the current, according to the method of claim 25.

In the same process this also proves to be the case for the electrolyte pressure, according to the method of claim 26, and for the relative machining speed according to the method of claim 27.

In a process wherein the current is applied in pulses, it is found advantageous to take the pulse period substantially equal to the measuring period, according to the method of claim 28. In such a process, the process conditions are not stable within a pulse period, leading to a significant and informative change of the measure voltage during this pulse period.

In a process wherein the current is applied substantially continuously, an advantageous method is obtained by selectively choosing the measuring period, according to the method of claim 29. Although generally such a process should have stable process conditions, and therefore no significant change in the measured voltage, deviations therefrom, may be detected. Such as those occurring at start-up, or at a disturbance during the process and or at reaching an end of the machining.

Further, control of some of the previously mentioned process control parameters appear to be particular useful taken alone or in combination, in order to avoid undesired process conditions.

A first advantageous method of electrochemical machining according to the invention is obtained by combining a method wherein the electric current is being supplied continuously with a method wherein the current is supplied intermittently, according to the method of claim 30. According to the first method, to be regarded as course material removing step, a large gap distance may be maintained and a high flow of electrolyte, causing a high rate of removal of material. According to the second method, to be regarded as a workpiece final shaping process, a subsequent accurate shaping may be obtained, due to a smaller gap. Such an accurate shaping not being feasible with the first without leading to undesired process conditions.

A further advantageous embodiment is obtained by applying in the workpiece final shaping step, a sequence of intermittently applied current according to the method of claim 31. This extends the ability to improve either the machining accuracy by allowing a smaller gap or either the ability to improve the surface quality of the workpiece, both without reaching undesired process conditions.

A next advantageous embodiment is obtained by applying in the workpiece final shaping step, passivation pulses according to the method of claim 36. This improves the machining accuracy in a high degree, as in front of the electrode a passivation layer will be dissolved and substantially less will be dissolved at the side of the electrode. Dissolving of the workpiece will therefore happen mainly in front of the electrode. Again undesired process conditions may be postponed in this manner.

A subsequent advantageous embodiment is obtained by applying pulses of an opposite polarity, according to the method of claim 37. Thus enabling the removal of passivation layers on the workpiece.

Also a method wherein electrode cleaning pulses are being applied according to the method of claim 38, appear to result in a method with a longer range of desired process conditions.

Further advantageous aspects of the invention are relating to an arrangement for electrochemically machining, are recited in the independent claims 39 and 68 respectively and in the dependent claims 40-67 and 69-76 respectively.

### BRIEF DESCRIPTION OF THE DRAWINGS

These and further aspects and advantages of the invention will be apparent from and elucidated in more detail hereinafter with reference to the disclosure of preferred embodiments, and in particular with reference to the appended figures in which,

FIG. 1 illustrates schematically an arrangement for electrochemically machining for carrying out the method of the invention;

FIG. 2 shows schematically a control circuit for controlling the arrangement of FIG. 1 in accordance with the method of the invention;

FIG. 3 shows an embodiment of power supply circuitry to be used in the control circuit of FIG. 2;

FIG. 4 illustrates a method of electrochemical machining;

FIG. 5 illustrates another method of electrochemically machining;

FIG. 6 illustrates a further method of electrochemically machining;

FIG. 7 shows characteristic examples of measured voltages during a predetermined measuring period induced by applying current to an electrochemical cell;

FIG. 8 shows a first embodiment of the method according to the invention for determining a characteristic waveform of a measured voltage such as shown in FIG. 7 and deriving spectral information therefrom;

FIG. 9 illustrates the method of FIG. 8;

FIG. 10 shows an example of spectral information obtained with the method described with reference to FIG. 8 and FIG. 9;

FIG. 11 shows a first example of assigning specific process conditions to spectral information, in accordance with an embodiment of the invention;

FIG. 12 shows a further embodiment of the method according to the invention for deriving spectral information;

FIG. 13 shows an embodiment of a control unit for carrying out the method of the invention,

FIG. 14 to FIG. 18 are showing several methods according to the invention of controlling a process of electrochemically machining,

FIG. 19 shows an example of Fourier coefficients Ck corresponding to type I process conditions as a function of gap size S and minimum applied voltage Umin;

FIG. 20 shows an example of Fourier coefficients Ck corresponding to type II process conditions as a function of electrolyte pressure Pin,

FIG. 21 shows an example of Fourier coefficients Ck corresponding to type III process conditions as a function of gap size S and

FIG. 22 shows another example according to the invention of controlling a process of electrochemically machining.

### DESCRIPTION OF THE EMBODIMENTS

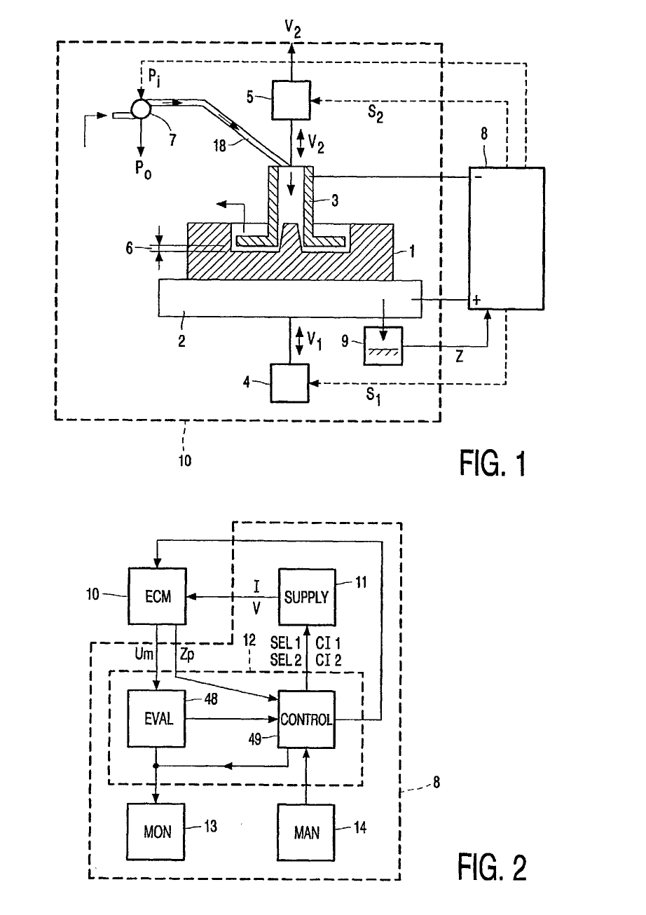

FIG. 1 illustrates schematically an arrangement for electrochemically machining a workpiece 1. The workpiece 1 is carried by a table 2 which moves with a feed rate V1, by means of first positioning means 4, towards an electrode tool 3. The workpiece 1, the electrode tool 3 and the table 2 are electrically conductive. The electrode tool 3 may be moved relative to the workpiece 1 with an electrode feed rate V2 by means of second positioning means 5. The second positioning means 5 may cause the electrode tool 3 to perform an oscillatory movement such as a harmonic movement or a non-harmonic repeated movement relative to the workpiece 1. This may be realized by means of, for example a crank shaft which is driven by a motor or by hydraulic means. The first positioning means 4 may comprise linear displacement means comprising a threaded shaft. The first positioning means 4 are controlled by a first positioning control signal S1 while the second positioning means 5 are controlled by a second positioning control signal S2. The workpiece 1 may be made of, for example a hard metal such as titanium or an alloy, such as chromium containing steel. An electrolyte 18, for example an aqueous solution of nitrates of alkaline metals, flows in the gap 6 between the workpiece 1 and the electrode tool 3 and is circulated with an input pressure Pin and an output pressure Pout from a reservoir, not shown in the figure, by suitable circulating means 7 employing a pump. The electrode tool 3 and the table 2 are connected to a control circuit 8 comprising an electric power source that induces an electric current between the electrode tool 3 and the table 2 via the electrolyte 18. The induced electric current may be constant or pulsed. The normal polarity being that the table 2, and consequently the workpiece 1, is positive relative to the electrode tool 3. During current pulses of normal polarity the metal of the workpiece 1 dissolves in the electrolyte. A position of the table 2 is measured by position sensing means 9, which supplies a corresponding position signal Z to the control circuit 8. The part of the arrangement shown in FIG. 1 excluding the control circuit 8 will be denoted hereinafter to as the electrochemical process unit 10.

FIG. 2 shows schematically an embodiment of the control circuit 8 of FIG. 1 in more detail. The control circuit 8 is separated in a power supply unit 11, a control unit 12, monitoring means 13 and manual control means 14. The power supply unit 11 generates the required electric current I or voltage V, which is applied to the electrochemical process unit 10. The power supply unit 11 may comprises several power supply sub units, not shown in the figure, to generate either a constant current or several types of pulsed current. It is noted that the power supply sub units do not need to be integrated in one unit but may be arranged in a system of cooperating independent sub units. The control unit 12 controls the operation of the power supply unit 11 with power supply control signals SEL1, SEL2, CI1, CI2 . . . in accordance with the employed method of controlling and with received measurement signals Um, Z, P . . . from the electrochemical process unit 10. The monitoring means 13 may comprise simple visual indicators, measurement devices or general display means. The manual control means 14 are used by an operator and may comprise simple switching means as well as general keyboard. It is further noted that the control unit 12 may be constituted either in part or as a whole as dedicated hardware with a specific function or as a general-purpose computer loaded with a specific program.

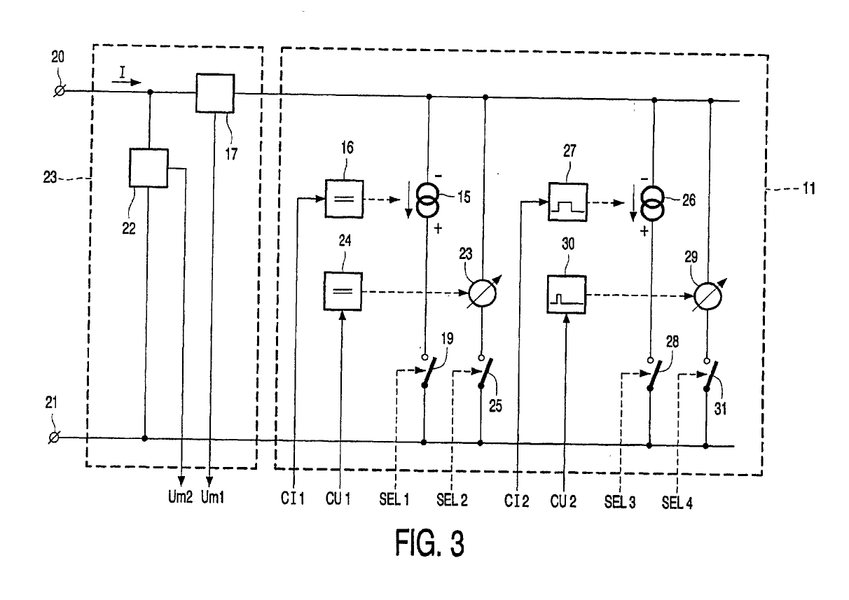

FIG. 3 shows in more detail an embodiment of the power supply unit 11 of FIG. 2 for carrying out the method according to the invention. The power supply unit 11 comprises a constant current source 15, which supplies a continuous current whose magnitude is controlled by the control signal CI1, via an interface 16, which may be formed by, for example, digital-to-analog converters. The control signal CI1 is generated by the control unit 12. The negative terminal of the current source 15 is connected to the electrode tool 3 via an optional current measuring circuit 17. This current measuring circuit 17, which may comprise a single electric resistor connected in serial, is used to derive a measurement voltage Um1, indicative of the current applied to the electrochemical process unit 10. The positive terminal of the constant current source 15 is connected to switching means 19, which is controlled by a selection signal SEL1, generated by the control unit 12. A voltage Um2 measured across the power supply output terminals 20 and 21 is measured by voltage measuring circuit 22. It is remarked that the current measuring unit 17 and/or the voltage measuring unit 22 may be embodied as a special measuring unit 23 located apart from the power supply unit 11 but close to the electrochemical process unit 10.

The power supply unit 11 further comprises a constant voltage source 23 for supplying a constant voltage to the electrochemical process unit 10. The amplitude of the voltage generated by the constant voltage source 23 is controlled by a control signal CU1 via an interface 24. An output terminal of the constant voltage source 23 is connected to switching means 25 which is controlled by a selection signal SEL2. The control signal CU1 and the selection signal SEL2 are generated by the control unit 12. As will be elaborated later in more detail, an additional voltage, which may be of the opposite polarity, may be applied advantageously to the electrochemical process unit 10.

Alternately, a pulsed current source 26 is present for supplying current in pulse like periods. The pulsed current source 26 is controlled by a control signal CI2 via an interface 27. It is noted that not only the amplitude of the supplied current may be controlled but also the relation of pulse amplitude versus time. The pulsed current source 26 may be connected to the electrochemical process unit 10 by switching means 28, which are controlled by a selection signal SEL3. It is noted that special circuitry is required for generating a pulsed current, due to requirements to pulse shape and pulse duration. Although examples will be given hereinafter, typical pulse periods may be expressed in 1 to 100 ms.

Finally a special pulsed current source 29 is present for generating current during extreme short periods, ranging from 10 to 100 μs with an extreme steep forefront of approximately 0.5 μs. The special pulsed current source 29 is controlled by a control signal CI2 via an interface 30 and selected by a selection signal SEL4, which controls switching means 31.

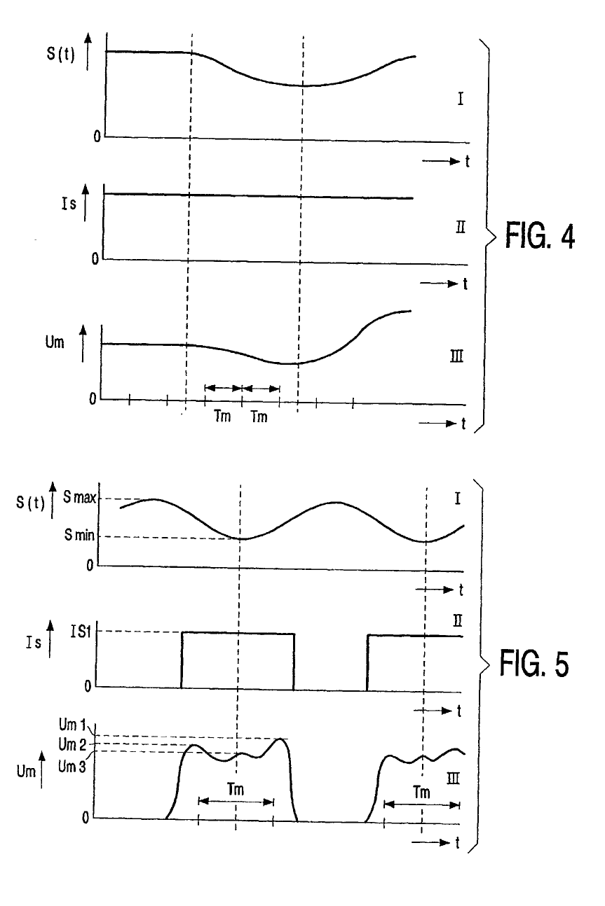

Curve I in FIG. 4 represents the variation of the size S(t) of the gap 6 between the workpiece 1 and the electrode tool 3 during applying a constant current. Curves II and III in FIG. 4 show the variation of the measured voltage Um across the gap 6 and the current Is applied through the gap 6 respectively. In practice, during the electrochemical machining process, the gap 6 is kept substantially constant by choosing the feed rate V1 of the table 2 equal to the rate by which the metal of the workpiece 1 dissolves. However, small variations of the size S(t) may occur, such as indicated as an example with curve I. These variations may be due to varying process conditions, such as changing characteristics of the surface of the workpiece 1 or pollution of the electrode tool 3 or electrolyte 18. These variations in size S(t) may lead to variations in the measured voltage Um, during a measuring period Tm, as indicated with curve III. For instance, a smaller size S(t) may lead to a smaller voltage Um, due to a smaller resistance formed by the smaller amount of electrolyte 18 in the gap 6.

Curve I in FIG. 5 represents the variation of the size S(t) of the gap 6 between the workpiece 1 and the electrode tool 3 during an oscillatory movement relative to each other with a maximum size Smax and a minimum size Smin and applying pulsed current Is according to curve II. Curve III shows the measured voltage Um across the gap 6. If no current Is is applied, no voltage Um is present. However, when a current Is of amplitude Is1 is applied, the measured voltage Um rises quickly. The distance S(t), in an initial stage, is comparatively large and the electrolyte flow may be turbulent and containing vapor and gas bubbles. Therefore the resistance across the gap 6 is relatively high, which is apparent from the first maximum Um2 of the measured voltage Um in curve II. As a result of the approach of the electrode tool 3, the pressure in the electrolyte 18 increases, causing the vapor and gas bubbles to dissolve so that the electrolyte 18 is homogenous and uniform in the gap and a high current density can be achieved with a small gap size. As a consequence, the electrical resistance decreases, which is apparent for the occurrence of a local minimum of the voltage Um in curve II. As a result of the increasing distance S(t) and a renewed formation of vapor and gas bubbles, the electrical resistance increases again leading to a second maximum Um2 of the voltage Um. The application of electric power may be so large that the electrolyte begins to boil violently, giving rise to extra bubble formation in the gap 6. This causes a temporary increase of the electrical resistance of the electrolyte 18, which manifests itself as a local maximum Um1 of the voltage Um.

Such a process of electrochemical machining is for instance described in more detail in document D2 of the list of referred documents that can be found at the end of this description, which is included by reference. A typical current density of the current pulses of normal polarity is 100 A/cm², the length of the pulse period 3 ms and an oscillation frequency about 50 Hz. The oscillation amplitude may be 0.2 mm.

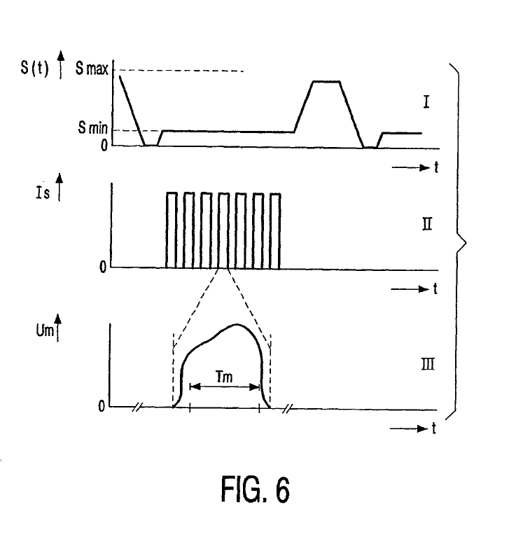

Curve I in FIG. 6 represents the variation of the size S(t) of the gap 6 between the workpiece 1 and the electrode tool 3 during a repeated movement relative to each other with a maximum size Smax and a minimum working distance Smin. Before establishing the working distance Smin, the distance S(t) is reduced until the workpiece 1 and the electrode tool 3 come in contact with one another. By monitoring the voltage Um, the instant of zero distance S(t) can be determined and consequently the working distance Smin can be adjusted accurately. A typical working distance may be smaller than 50 μm. After the working distance of Smin has been set, a sequence of current pules is applied, as illustrated with curve II in FIG. 6. After applying this sequence of pulses, the gap is enlarged to the size Smax to enable a renewal of the electrolyte as the electrolyte 18 will be rapidly saturated due to an inadequate flow rate during machining. Curve III of FIG. 6 gives an exploded view of the variation of the voltage Um caused by a current pulse during a measuring period Tm. A more detailed description of this process of electrochemical machining is described in more detail in document D3 of the list of referred documents that can be found at the end of this description, which is included by reference.

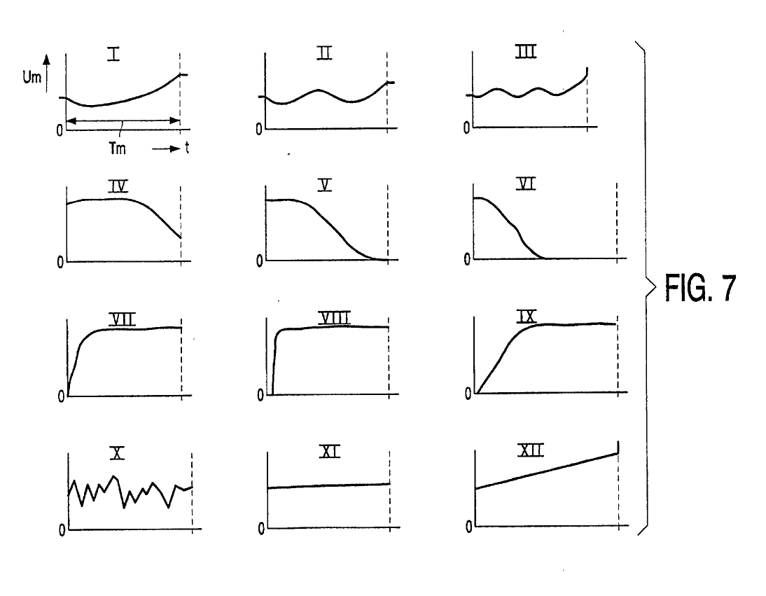

As already illustrated with reference to the FIGS. 4-6, the measured voltage Um across the gap, caused by the current flowing through the gap, shows significant variations in the relation of amplitude Um versus time t. FIG. 7 shows some characteristic examples of measured voltages Um during a predetermined measuring period Tm induced by applying current to an electrochemical cell. Curve I illustrates an example as may occur during applying current pulses in combination with an oscillatory movement such as illustrated with reference to FIG. 5. It is noted that only the voltage Um within a measuring period Tm smaller then a pulse period is shown, leaving away the less informative parts of the measured voltage. Typically one local minimum is present at approximately at the instant of smallest size S(t) of the gap 6. At the end the voltage Um increases due to increasing size S(t). Curve II illustrates an example with different process conditions, characterized by the occurrence of a local maximum due to a non-uniform electrolyte caused by generation of bubbles due to a high current density. Curve III gives an example illustrating even worsening process conditions, characterized by the occurrence of several local maxima.

In case of applying current pulses with a constant size S(t) of the gap 6, such as illustrated with reference to FIG. 6, the feasible pulse duration may be a characteristic indicator of the process conditions. For example, curves IV, V and VI are illustrating different durations of the measured voltage Um. It is noted that the corresponding current pulses as generated by a power supply unit 11 may all have the same pulse period. Only due to the rapidly increasing electrical resistance during application of the current pulse, the applied current cannot be maintained across the gap 6 and the measured voltage Urn decreases.

Curves VII, VIII, IX illustrates examples of different slopes of the forefront of measured voltage Urn, when applying current pulses with extremely short duration. For example, a favorable process condition may be obtained with a steep increase of the measured voltage Urn, as in that case less time is left for generation of bubbles in the electrolyte 18.

Curves X, XI and XII illustrate typical examples of the measured voltage Urn as may occur when applying a substantially constant current, as explained with reference to FIG. 4. The measuring period Tm is chosen such that significant changes in process conditions may be detected in time. For example with curve XI illustrating stable process conditions and with curve XII illustrating changing process conditions, due to for instance changing composition of the electrolyte 18 or changing flow of electrolyte. Curve X illustrates a process condition with increased noise of the measured voltage Urn. This may be indicative of near short circuit conditions, caused by local discharges.

It is remarked that the above given examples are merely illustrative of typical effects. Other effects, alone or in combinations may lead to a variety of measured forms.

Next will be explained how to quantify the information present in the measured voltage Urn, in accordance with the invention, in order to be employed as a control parameter in a method of controlling a process of electrochemically machining, either manually or automatically.

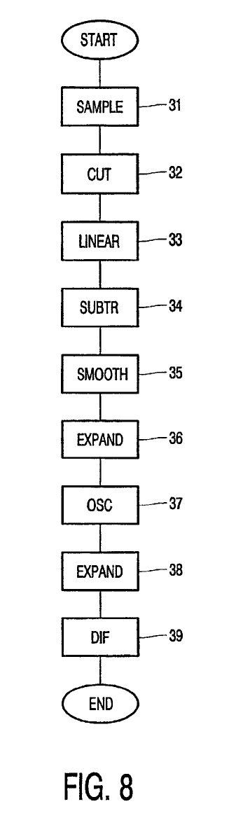

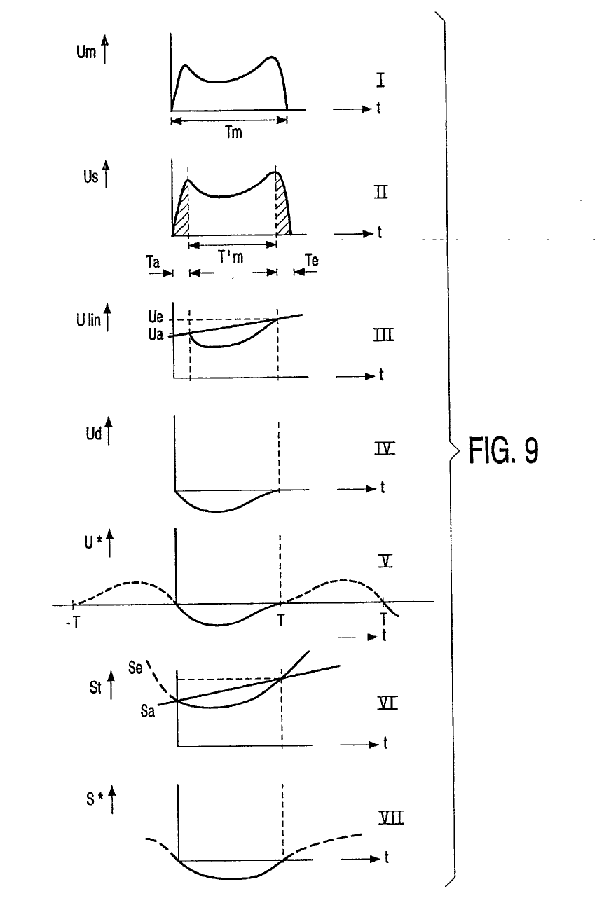

FIG. 8 shows a first embodiment of such a method according to the invention for determining a characteristic waveform of a measured voltage Urn such as shown in FIG. 7. The respective steps will be explained with reference to FIG. 9, showing the immediate results of quantifying. The method will be explained with reference to a measured voltage Urn as a function of time t as shown as curve I in FIG. 9. This curve I may be induced by a current pulse applied during an oscillating movement of electrode tool 3 and workpiece 1 relative to each other, according to a process of electrochemically machining as illustrated with reference to FIG. 5 The measuring period Tm is chosen equal to the pulse period, which information may be obtained from the power supply unit 11. It is remarked that although the depicted curves seem to be continuous, in practice sampled and digitized points of the curves will be used. Preferably a table of sampled values Ui (Ti) versus time instants Ti is used to characterize the measured voltage Um as a function of time t. This is performed with a sampling step 31.

Subsequently, excluded from this table are samples during initial and final parts of the measured sampled voltage Us(t) that are occurring during a transitive process in the power supply unit 11. This is done in a cutting step 32 where an initial part Ta and a terminal part Te, connected to a transient process are being excluded from the measuring period Tm to obtain a corrected measuring period Tm′. Information with respect to the size of these parts Te and Ta may be obtained either from the power supply unit 11 or may be obtained by analyzing the measured samples. Alternatively, the size of Te and Ta may be determined in advance. Further, the measuring period Tm may be chosen in advance such to exclude transient parts from the beginning. The resulting sampled form Us(t) after cutting is shown as curve II in FIG. 9.

Next, in a linearization step 33, a linear function Ulin(t) is derived from the samples Us determined so far. The linear function Ulin(t) is characterized by the values Ua and Ue of the measured sampled voltage Ui at the beginning and at the end respectively of samples Us resulting after cutting and is given by:

Ulin(t)=Ua+((Ue−Ua)/T*)·t [1]

with T*=Tm′. Curve III in FIG. 9 shows an example of such a linear function Ulin(t)

Next, in a subtracting step 34, the linear function Ulin(t) is subtracted from the sampled function Us(t) to obtain a differential function Ud according to:

Ud(t)=Us(t)−Ulin(t) [2]

The resulting differential function Ud (t) is shown as curve IV in FIG. 9.

Subsequently, in a smoothing step 35, a smooth continuous function U*(t) is formed by conjugation of the differential function Ud (t). This is done by symmetrically reflecting the differential function Ud (t) relative to the horizontal and vertical axis, as shown as curve V in FIG. 9. The resulting smooth function U*(t) is a periodically odd function, that has a continuous first derivative.

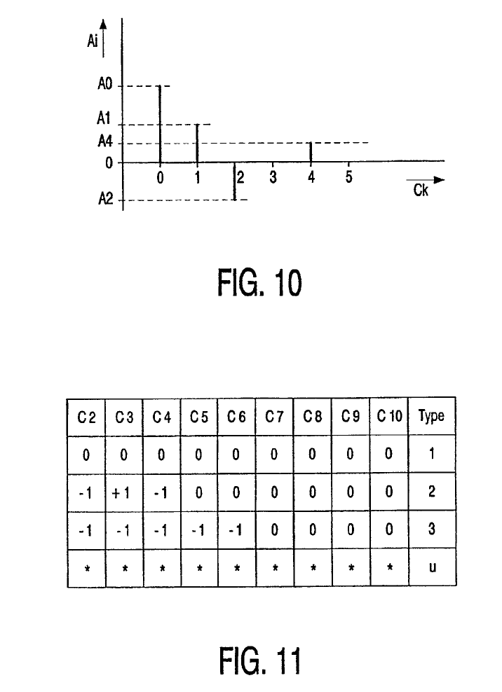

Next, in an expansion step 36, the function U*(t) is expanded in a Fourier series with Fourier-coefficients Ck and corresponding amplitudes Ak. As the function U*(t) is an odd function, all cosine coefficients will be equal to zero. Expansion is thus made by only sine coefficients. A typical result of such an expansion is shown in FIG. 10. Herein the amplitude Ak of the corresponding Fourier coefficients Ck are shown. As is generally known, the Fourier coefficients Ck represent trigonometric functions such as sine and cosine functions of different repetition period or wave length. The coefficient C0 denotes merely an offset, the coefficients Ck with k=1, 2, . . . denoting the k numbered harmonics of an elementary sine or cosine function with repetition period 2T (of curve V in FIG. 9). The harmonic numbered k in this respect is denoting the trigonometric function with a repetition period equal to the 2T/k. However, it is remarked that the definition of numbering is arbitrary.

The following step is a oscillating function building step 37, where a sinus function is build that corresponds to the oscillating movement of the electrode tool 3 and workpiece 1 relative to each other, according to a process described with reference to FIG. 5 with curve I. The distance S(t) of the gap 6 is represented by the following function:

S(t)=sin[ω(t−T*/2)+π/2] [3]

with ω the oscillating frequency in rad/s. Curve VI illustrates this function S(t). Analogous to the previous linearizing step 33, a linear function Slin(t) is build based on the sizes Sa and Se of the function S(t) at the start and the end of the corrected measuring period, as shown schematically with curve VI in FIG. 9:

Slin(t)=Sa+(Se−Sa)/T*·T [4]

Also analogously, this linear function Slin(t) is subtracted from the function S(t) to obtain a differential function Sd(t):

Sd(t)=St(t)−Slin(t) [5]

Next, still in the oscillating function building step 37, a smooth continuous function S*(t) is formed by conjugation of the differential function Sd(t). This is done by symmetrically reflecting the differential function Sd(t) relative to the horizontal and vertical axis, as shown as curve VII in FIG. 9. The resulting smooth function S*(t) is a periodically odd function, that has a continuous first derivative.

Next, in a second Fourier expansion step 38, this function S*(t) is expanded in a Fourier series with corresponding Fourier coefficients C*k and amplitudes A*k) again analogous to step 36.

In a subtracting step 39 the coefficients Ck are subtracted from the corresponding coefficients C*k to obtain corrected coefficients C′k:

C′k=Ck−A·C*k(k=1,2, . . . ) [6]

The value of A is defined by the method of least squares by minimizing the function:

Φ(A)=Σ_{k=1,2 . . .} (Ck−A·C*k)² [7]

The minimum of A takes places when:

$$A = \frac{{\sum }_{k = 1 , 2 …} Ck \cdot {C}^{*} k}{{\sum }_{k = 1 , 2 …} {C}^{*} {k}^{2}} \qquad [ 8 ]$$

An example of a resultant series of corrected coefficients Ck with amplitude Ai is shown in FIG. 10.

It is remarked that the above given expansion of the measured voltage Um within the measuring period, is one of several ways to expand. Expansion may equally take place in cosine functions, if an even function is more appropriate or may take place as a combination of sine or cosine functions. Moreover, the method according to the invention is not restricted to expansion in trigonometric functions only. Expansion may also take place in a series of other appropriate elementary functions.

Further it is noted that a conversion of the measured voltage from the time domain to the frequency domain, such as is done by the above-mentioned Fourier transformation, is not the only method to obtain the spectral composition. The spectral information may equally be obtained by performing an autocorrelation in the time domain or by employing suitable frequency band filtering.

It is also noted that subtracting a linear function is not essential to the method of the invention, but is to be regarded as an advantageous embodiment. The same accounts to subtracting the coefficients corresponding to an oscillatory movement. Herewith it should be realized that the above given example of expansion has been illustrated with reference to a specific process, involving pulsed current with an oscillatory movement of electrode tool 3 en workpiece 1. In case of no relative movement during a measuring period, such subtraction may be less advantageous. On the other hand, different kinds of movements may be present and which need to be corrected for.

The above described may be performed employing with dedicated hardware, a general purpose computer programmed with suitable software or a combination of both. Further to increase speed, as typically every 20 ms a decision may be necessary, tables with sine and cosine values may be employed. The number of harmonics may be limited approximately to 10, as low frequency distortions can be described by 10 harmonics with a precision of about 1%.

Table 11 illustrates the assignment of characteristic series of Fourier coefficients Ck to corresponding types of process conditions. The values are of course limited to the process of electrochemical machining used, such as the one used for explaining the method of expansion. Other processes will lead to other values and to other typical types of process conditions. It is up to the skilled operator to determine the characteristic series of Fourier coefficients Ck and the corresponding assignment to process conditions, by means of trial or error. This may even depend on the type of workpiece to be machined.

A type 1 process condition is assigned to the absence of the harmonics 2-10, indicated with the value ‘0’. Type I process conditions are being characterized by appearing of a dark-gray or black film on the machining surface, high roughness and a low productivity caused by a low current density.

A type 2 process condition is assigned to the presence of the harmonic numbered 2 and 4 with a negative amplitude ‘−1’ and of the harmonic numbered 3 with a positive amplitude ‘+1’. Type 2 process conditions are being characterized by the appearing of a dense dark file on the machining surface, high roughness, low productivity caused by boiling up of the electrolyte or reaching a limit value of gas-filling of the electrolyte.

A type 3 process condition is assigned to the presence of the harmonics numbered 2, 3, 4, 5 and 6 with a negative amplitude. Type 3 process conditions are being characterized by the appearing of a regular wavy surface along the electrolyte flow, a low precision of copying and a high power consumption.

An undefined process condition “u” is assigned to situations not recognized “*”.

It should be realized that the values given in table 10 are only one example. The number of types of process conditions may be extended if necessary while several series of Fourier coefficients may be assigned to one type of process conditions.

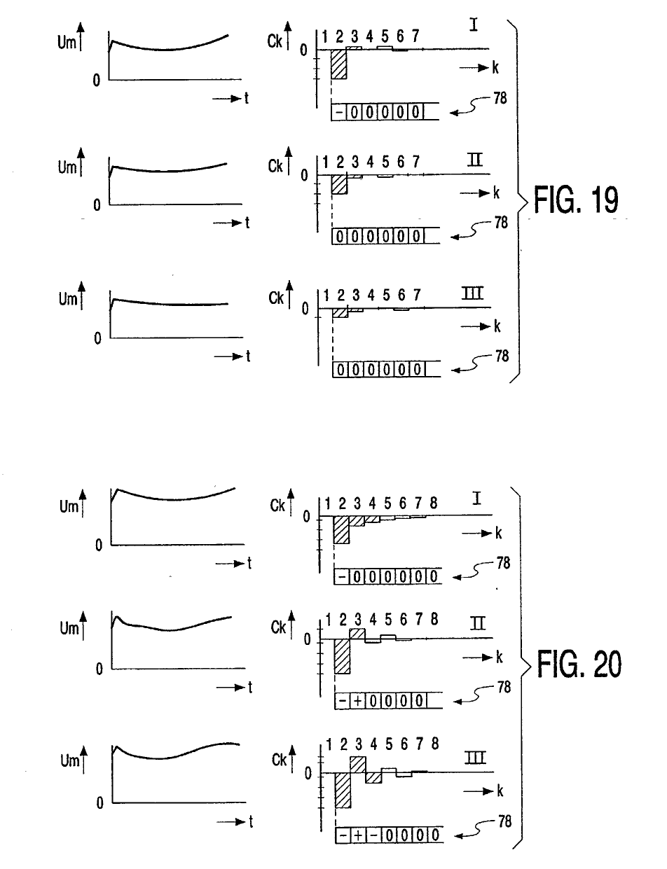

Next, with reference to the FIGS. 19-21, various examples of Fourier coefficients Ck will be given, as a function of varying process control parameters. The process taken as example is a process employing an oscillating movement and current pulses as disclosed with reference to FIG. 5. The Fourier coefficients Ck and a horizontal bar 78, respectively representing the size and presence of n-numbered harmonics, will be shown for various waveforms constituted by the measured voltage Um versus time t.

FIG. 19 shows the Fourier coefficients Ck as a function of the process control parameters for the gap size S and a minimal applied voltage across the gap Umin. Umin is related with the minimal voltage present during applying a pulse. The electrolyte pressure is kept constant at a value of 300 kPa. Shown are the measured voltage Um and the value Ck of the corresponding Fouriercoefficients. Curve I depicts the situation with Umin=9.0 V and S=22 μm, curve II with Umin=5.0 V and S=18 μm and curve III with Umin=4.0 V and S=3 μm. The flattening waveform depicted by Um versus time t, is reflected by the decrease of the Fourier coefficients Ck. A type I process condition as shown with bar 78 for curve I is gradually changed in a process condition with no harmonics as shown with bar 78 of curve III.

FIG. 20 shows the Fourier coefficients Ck primarily as a function of the process control parameter for the electrolyte pressure Pin for the same process with constant minimal applied voltage Umin=10.0 V and approximate constant gap size S. Curve I depicts the situation with Pin=400 kPa and S=30 μm, curve II with Pin=100 kPa and S=46 μm and curve III with Pin=30 kPa and S=36 μm. Reducing the pressure Pin results in the generation of a local maximum in the waveform constituted by Um. This is reflected by Fouriercoefficients of alternating sign, leading to a type 3 process condition as shown by bar 78 of curve III.

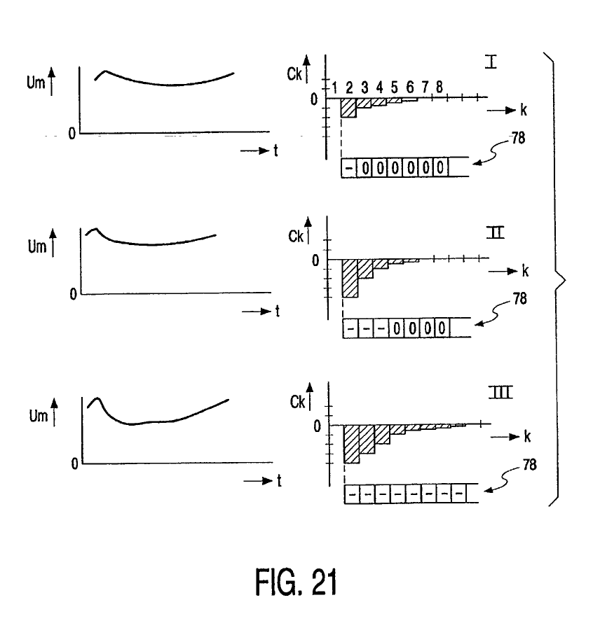

FIG. 21 shows the Fourier coefficients Ck as a function from the gap size S of the same process. The electrolyte pressure Pin is kept at 400 kPa while the minimum applied voltage Umin is kept to 10.0 V. Curve I depicts the situation with S=26 μm, curve II with S=36 μm and curve III with S=46 μm. It can be seen that with an increasing size S, gradually a type 3 process condition is being obtained.

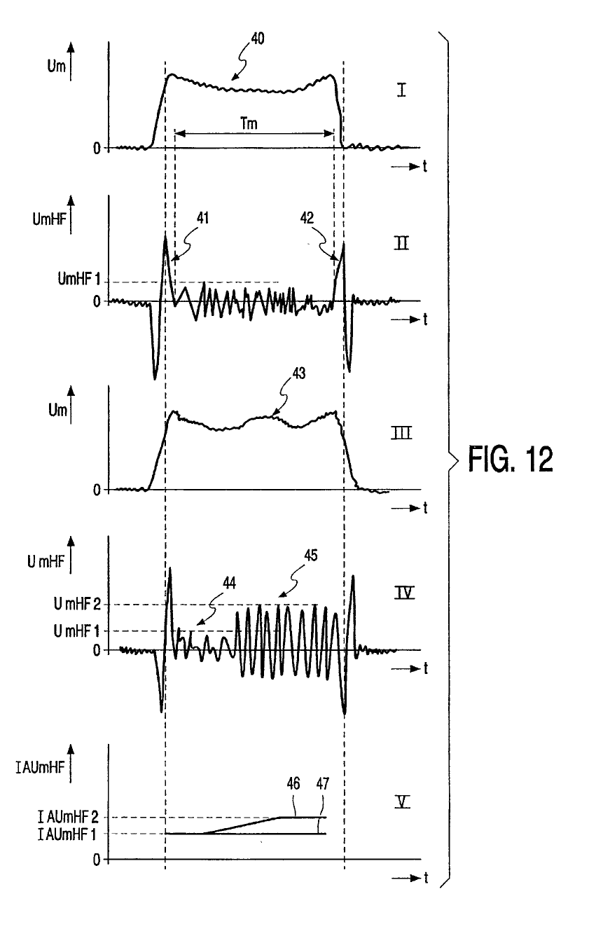

FIG. 12 shows a further embodiment of the method according to the invention for deriving spectral information. Curve I of FIG. 12 shows an example of measured voltage Um in case of applying a current pulse. In this embodiment the high frequency information content is analyzed in stead of the low frequency content as defined by a number of up to 10 harmonics as described before. The high frequency content comprises harmonics substantially higher then 10. The indicated area 40 indicates typical high frequency variations. Curve II in FIG. 12 shows the measured voltage UmHF after amplification and high pass frequency filtering the voltage Um. The measuring period Tm should be chosen such that the large spikes 41 and 42 present at the beginning and at the end of the measured pulse, should be excluded. These spikes are mainly due to switching actions in the power supply circuit and are not characteristic of process conditions. The depicted curves I and II may be indicative of normal process conditions. However, curve III in FIG. 12 corresponds to a changed process condition, as indicated by the distortion 43. Curve IV shows again the amplified and high pass frequency filtered measured voltage UmHF. Two parts can be distinguished in this curve IV: a part 44 with relatively low amplitudes and a part 45 with relatively high amplitudes. The part 44 being indicative of a so-called before accident ECM regime. With an accident ECM regime is meant a process conditions with the occurrence of electrical discharges. The occurrence of such a process condition should be avoided as the electrode tool or workpiece may be damaged. The change in amplitude of the high frequency content as indicated with UmHF appears to be a good indicator of such a before accident ECM regime.

The occurrence of such high frequency content may be determined by the presence and change of amplitude of high numbered harmonics, for example higher than 10, as established by expanding the measured voltage Um in a Fourier series according to the method disclosed with reference to FIGS. 8 and 9. However, alternatively an advantageous method is obtained by, as already indicated with reference to curves II and IV in FIG. 12, amplifying and high pass frequency filtering the measured voltage Um. This may be realized by for example a simple amplifier and a high pass frequency filter circuit. A typical amplifying factor may be 100 while a typical cut-off frequency should be greater than about 20 kHz in case of pulse period of 3 ms. It is noted that a pulse period of 3 ms has lowest numbered harmonics with frequencies ranging up to 10 kHz.

After having obtained the amplified and high pass frequency filter voltage UmHF as shown in curve IV of FIG. 12, a further advantageous method is obtained by taking the absolute value thereof: AUmHF. It is noted that the valued of Um or UmHF may be sampled and digitized, so all steps may be performed digitally. For example a number of sampling points may be chosen equal to 2000 during a measuring period Tm. Next a running average IAUmHF of AUmHF may be obtained with respect to a specific interval, for instance of 300 points. Curve V in FIG. 12 illustrates two possibilities that may result: one curve 47 corresponding to a normal ECM process condition such as indicated with curve II and one curve 46 corresponding to a before accident ECM process condition corresponding with curve IV. The occurrence of a difference between a reference value of IAUmHF and an actual value, may be chosen as indicator.

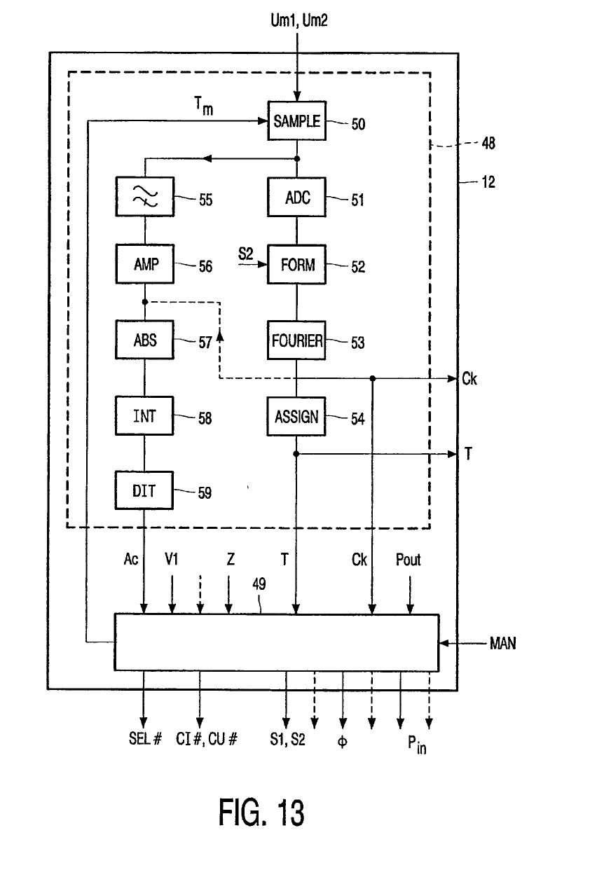

FIG. 13 shows an embodiment of a control unit 12 of FIG. 2 for carrying out the method of the invention. Such a control unit 12 may be distinguished in two units: an evaluating unit 48 and a regulating unit 49. The evaluating unit 48 is used for determining the frequency content of the measured voltage Um (corresponding to either Um1 or Um2) according to the method of the invention. The regulating unit 49 is used for controlling the process of electrochemically machining employing the results of the evaluating unit 48 and other measurement signals.

First an embodiment of an evaluating unit 48 for carrying out the method of the invention will be explained. A sampling unit 50 is receiving the measured voltage Um1 or Um2 induced by the applied current to electrode tool 3 and workpiece 1, as shown with reference to FIG. 3. The sampling unit 50 receives a sampling signal Tm indicative of the sampling period. This sampling signal Tm is generated by the regulating unit 49 and is, in case of pulsed current, mainly determined by the employed pulse period. In case of a constant current, predetermined values may be used. The sampling unit 50 selects parts of the measured voltage Um1 or Um2 in correspondence with the sampling signal Tm

The sampled signals are then supplied to a low frequency determining part comprising an analog-to-digital converter 51, a form function generating unit 52, a Fourier expansion unit 53 and an assignment unit 54. The form function generating unit 52 generates a form function indicative of the sampled values of Um during a sampling period corresponding to the measuring period Tm. The form function generating unit 52 further receives a signal S2 indicative of the relative movement of the electrode tool 3 and the workpiece 1. Herewith a form function indicative of this movement is being generated. The generating of both form functions may be carried out with the method disclosed with reference to FIG. 8 and FIG. 9.

These form functions are expanded in a Fourier series with the Fourier expansion unit 53 in a manner as explained with reference to FIG. 8 and FIG. 9. The Fourier expansion unit 53 supplies corresponding Fourier coefficient signals Ck to monitoring means 13 for display and to assignment means 54. Assignment means 54 are assigning typical process conditions to characteristic series of Fourier coefficients Ck in a manner as explained with reference to table 1. A resulting signal T represents the type of process condition is being outputted to monitoring means 13 and to the regulating unit 49.

The sampled signals generated by the sampling unit 50 are also supplied to a high frequency determining part comprising a high pass filter 55, an amplifier 56, an absolute value unit 57, an averaging unit 58 and a difference unit 59. The sampled signals supplied to the high pass filter 55 may be analog or digital. As mentioned before, the high pass filter 55 should pass variations in the measured voltage Urn with frequencies from, for example, 20 kHz. The subsequent amplifier 56 is used to amplify the relative variations in voltage Um. At this stage it is remarked that in stead of using the amplified and filtered signals so far, the Fourier coefficients Ck such as generated by the Fourier expansion unit 53, provided that this unit is adapted to determine amplitudes of higher numbered harmonics.

The absolute value unit 58 takes the absolute value of the signal inputted while the averaging unit 58 determines a running average, both in accordance with the method disclosed with reference to FIG. 12. Finally, a difference unit 59 determines the difference between a result obtained with normal process conditions. A signal Ac representing the presence of a pre-accident process situation is supplied to the regulating unit 49.

It is noted that, the separate units in the evaluating unit 48 may be embodied as separate units of dedicated hardware or may be processing steps in a general software program loaded in a general purpose computer. Also combinations may be present, for instance, a Fourier expansion unit 53 may be implemented as an expansion board for a general purpose computer. Further the high frequency determining part may be embodied with analogue components.

Next the regulating unit 49 will be explained in more detail. The regulating unit 49 receives in addition to the signals already mentioned, amongst others, manually inputted control signals MAN, a signal Pout representing a pressure of the electrolyte 18, measured for example at an output of the electrochemical process unit 10, and a signal Z representing the position of the workpiece 1. The regulating unit 49 outputs current or voltage supply selection signals SEL1, SEL2 . . . , power supply control signals CI1, CU1, . . . , control signals S1 and S2 for controlling the feed rate V1 and the electrode speed V2 respectively and a control signal Pin for controlling a pressure of the electrolyte, for example a pressure at the input of the electrochemical process unit 10.

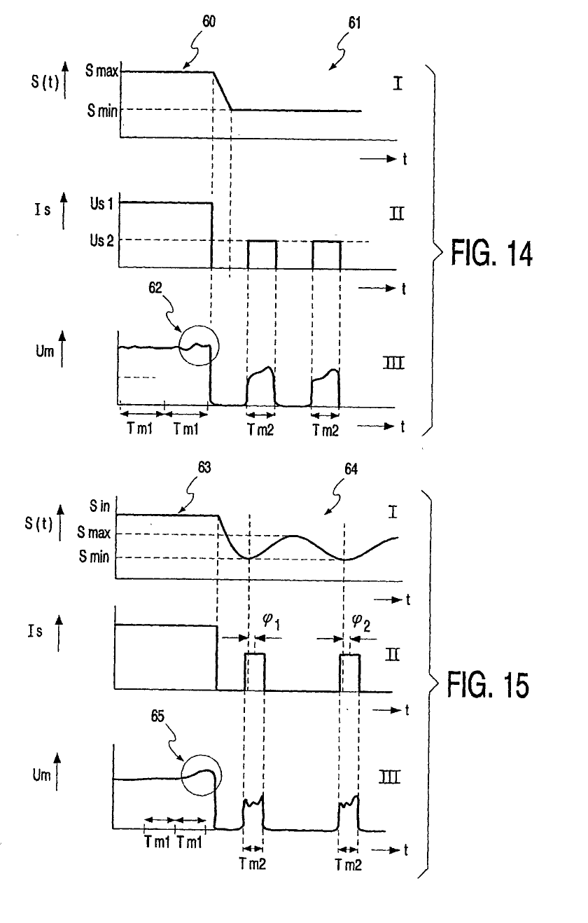

Next the operation of the regulating unit 49 will be explained in more detail, with reference to FIGS. 14-17, which show several methods according to the invention of controlling a process of electrochemically machining.

First, the high frequency information signal Ac and/or the type information signal T or Fourier coefficients signals Ck may be merely employed as limiting the operating range of the regulating unit 49. The regulating unit 49 controls the process of electrochemically machining within these limits. An advantageous control process for a process applying pulsed current and an oscillatory movement, employs as a process control parameters a pressure of the electrolyte 18, for instance the pressure Pin at the input of the electrochemical process unit 10. As the pressure is low, insufficient electrolyte flow will result, while a high pressure may result in a local cavitation or turbulence in the electrolyte. A further advantageous control process, in case of the same process, employs as a process control parameter the relative phase φ between the oscillatory movement and the start of a current pulse. Preferably both process control parameters are being employed. The process parameters Pin and φ are chosen in such a manner as to optimize the value of the feed rate VI.

However, it has been found that several other advantageous embodiments according to the invention are obtained when controlling other process parameters such as the time during which current is being applied, either pulsed or constant and/or the type and amount of relative movement between the electrode tool 3 and the workpiece 1. It has been found that undesired process conditions, as apparent from the spectral information derived from a measured voltage Um during a measuring period Tm, may be avoided by controlling these process parameters.

For instance, FIG. 14 illustrates a first method of controlling employing as a first process control parameter the supply of the current Is continuously or intermittently and as a second process control parameters the corresponding size S(t) of the gap 6. Curve I of FIG. 14 shows a first operational phase 60 when machining is done at a first size Smax and a second operational phase 61 when machining is done at a smaller size Smin of the gap 6. During the first operational phase 60 the current Is is applied continuously and during the second operational phase 61 the current Is is applied intermittently in pulse like periods, as illustrated by curve II in FIG. 14. Curve III shows the voltage Um as a function of time t. During the first operational phase 60, the voltage Um is determined in first measuring periods Tm1 and during the second operational phase 61 in second measuring periods Tm2. As can be seen in curve III, part 62 thereof shows a significant change of the voltage Um during the first phase. This indicates a change in process conditions, which is being monitored by the evaluating unit 48. The change in process condition may for instance indicate the end of a feasible range of machining the workpiece 1 with a high feed rate. This may be due to reaching a specific stage in shaping the workpiece 1, leading to a variation in local size S(t) of the gap 6. The evaluating unit 48 determines the corresponding type of process condition whereupon the regulating unit 49 reacts to by applying the current intermittently and at a shorter distance Smin. This enables to continue stable machining with an improved accuracy although with a lower feed rate of the workpiece 1.

FIG. 15 illustrates a second method of controlling employing as a first process control parameter the supply of current Is continuously or intermittently and as a second process control parameter either a constant size S(t) or an oscillating size S(t) of the gap between electrode tool 3 and workpiece 1. Curve I of FIG. 15 illustrates a first operational phase 63 with a constant supply of current Is at an initial size Sint and a second operational phase 64 with a pulsed supply of current Is during an oscillating movement. During the measuring periods Tm1, at part 65 of the curve III, an increase in measured voltage Um is measured by the evaluating unit 48, indicating for instance an increase of electrical resistance, caused by the formation of gas bubbles in the electrolyte 18. The regulation unit 49 causes the power supply unit 11 to apply only current during instants of smallest size Smin of an oscillatory movement. Thus avoiding formation of gas bubbles due to an increased electrolyte pressure in the gap 6 during the instants of smallest size. During the instants of largest sizes Smax of the oscillatory movement, no current is supplied and the liquid can be replenished. Changing from the first operational phase 63 to the second operational phase 64 enables maintaining stable process conditions. The voltage Um is still measured during the pulses during measuring periods Tm2, in order to determine the limit of process control parameters such as the phase φ between the moment of smallest distance and the moment of application of the pulse.

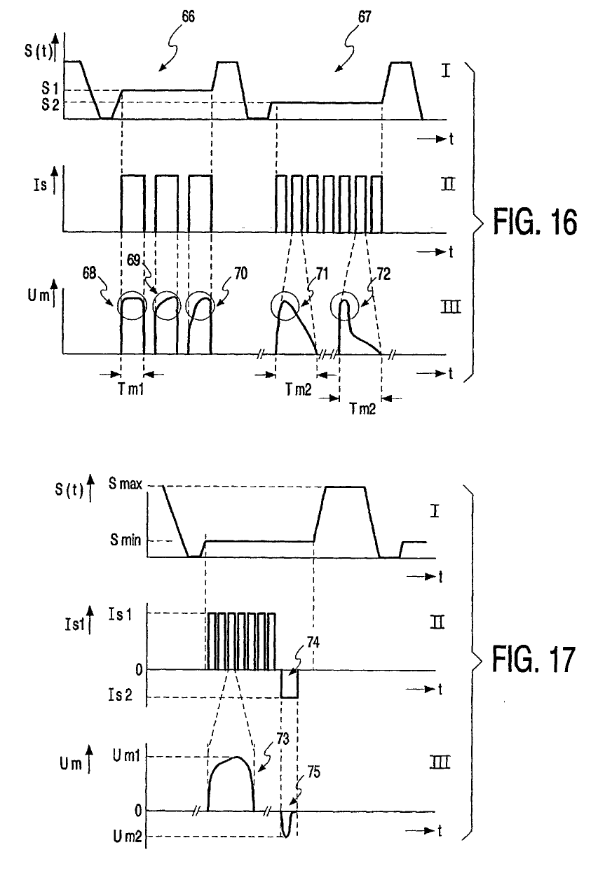

FIG. 16 illustrates a third method of controlling employing as a first process control parameter the supply of a sequence of current pulses Is at a first rate or at second rate, as illustrated by curve II, and as a second process control parameter the distance S(t) as illustrated by curve I. Two characteristic operational phases 66 and 67 are shown. The corresponding machining distances S1 and S2 are both obtained after bringing the workpiece 1 and electrode tool 1 in contact with each other. This enables a high positioning accuracy. As illustrated with parts 68, 69 and 70 of curve III in FIG. 16, the characteristic form of the measured voltage Um is changing with successive pulses, indicating worsening process conditions. In this example the pulse forefront varies. This may be an indicator that the machining distance may be reduced. The evaluating unit 48 supplies this information to the regulating unit 49, where upon the machining distance is reduced to a smaller value S2. To enable stable process conditions, the pulse rate is increased by shortening the pulse duration. It has been found that shortening of the pulse duration has the effect of leaving less time for generation of gas like bubbles, such as molecular hydrogen gas in the electrolyte 18. Preferably the pulse duration should be chosen small enough to avoid either forming of nuclei of atomic hydrogen that precede the formation of molecular hydrogen gas or forming of molecular hydrogen gas as such. In an embodiment the pulse duration should not exceed the time required to form molecular hydrogen gas. From the parts 71 and 72 of the curve III, it can be seen that it may be difficult to apply sufficient electric power within the short pulse period, thus reducing the machining speed. However it has been found that even more electric power can be applied if the pulse duration is being reduced to extremely short values, ranging from 10 to 300 μs. It has been surprisingly found that the current density may be increased with such a short pulse duration to values between 4000 and 6000 A/cm². However, essential for obtaining these high current densities is an extreme steep pulse up-slope with a value between 100-1000 ns. The pulse down-slope seems to be less relevant and should be less then 5 μs. The time duration or pauses between successive pulses should be large enough to enable escaping the generated molecular hydrogen gas, typically the duration between the pulses varies between 50-500 μs. The duration of a group of pulses varies between 20-1000 μs. However, as longer pauses also imply a reduction of machining rate, the pauses should not be taken to long. In a practical embodiment the ratio between a duration of a pause between the pulses and the pulse duration should be in a range between 2 and 10. The duration between applying groups of pulses range preferably between 20-5 ms. Preferably applying of pulses of these kind is done in combination with an oscillatory movement between electrode tool 3 and workpiece 1. The increase of local pressure within the gap 6 during the instant of smallest size S(t) of the gap 6 is advantageous in avoiding formation of gas bubbles. It is noted that with the extreme short pulses, the allowable electric field intensities in the gap may range between 2500 V/cm to 25000 V/cm with sizes of the gap between 5 μm to 45 μm.

It is noted that a high local pressure also results in avoiding formation of gas bubbles. Although the electrolyte input pressure Pin may be 2 bar, a local pressure may increase to 50 bar. In that case boiling will only occur at must higher temperatures.

Further the physical effect obtained under these extreme short pulses may similar to a local melting of the work piece. The local melt being formed in small ionized channels where after the molted material is immediately dispersed through the electrolyte.

Next a fourth method is illustrated with reference to FIG. 17. Curve I shows the variation of the size S(t)versus the time t. Before establishing the machining distance Smin, the electrode tool 3 contacts or taps the workpiece 1. Curve II in FIG. 17 illustrates that a sequence of machining current pulses with a normal polarity is being applied. As indicated by curve III in FIG. 17, the variation 73 of measured voltage Um induced by a current pulse may indicate, by evaluation of the Fourier coefficients, the formation of a sedimentation layer on the electrode tool 3. The electrode tool 3 itself may be made of metals like copper, chromium or chromium-nickel and the like. However metals like titanium will not lead to the formation of an oxide layer. This is also not likely to happen as during machining the electrode tool 3 is being kept at a negative voltage relative to the workpiece 1. However, what might happen is the attraction of positively charged particles such as remnants of acids, present in the electrolyte and the formation of a layer thereof on the electrode tool 3. These particles are not strongly attached to the electrode tool by due to a chemical reaction and therefore may be removed therefrom by applying temporally a positive voltage to the electrode tool 3. This is realized by inducing a current pulse 74 of a negative polarity such as illustrated in curve II. It is noted, that alternatively the same result may be obtained by applying a voltage pulse of inverted polarity. Applying such pulses causes the loosely attached sediments to go in solution again. In addition, the remnants of metals in the electrolyte such as chromium and nickel, which may be deposited on the electrode, known as the plating effect, may be removed by the above mentioned cleaning pulses. Applying cleaning pulses may be induced by changed geometrical values but also a reduced amount of flow of electrolyte.

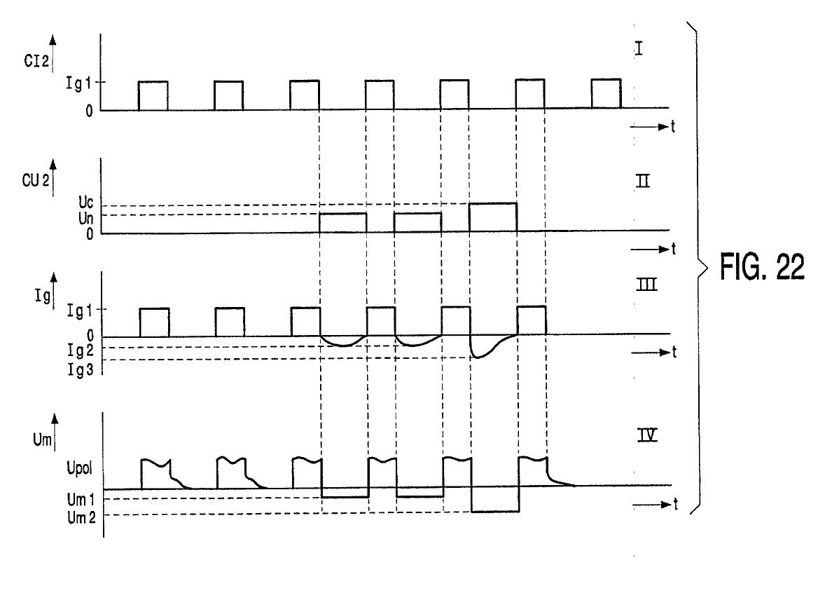

FIG. 22 illustrates a next advantageous method of combining two kinds of voltage pulses of inverted polarity with a current pulse of normal polarity. Curve I depicts the generation of a sequence of current pulses of normal polarity with amplitude Ig1 induced by control signal CI2 as described with reference to FIG. 3. Curve II depicts the generation of a sequence of voltage pulses of opposite polarity with a first amplitude Uc and a second amplitude Un induced by control signal CU2 as described with reference to FIG. 3. The voltage pulses with amplitude Un serving to dissolve a passivating layer formed on the workpiece 1, in accordance with the method disclosed in more detail in document D2 in the list of referred documents which can be found at the end of the description. A passivation layer is formed by a dark oxide film. The required voltage depassivation voltage Un should preferably lie between the polarization voltage Upol, which is explained with reference to curve IV, and the voltage Unmax at which the electrode begins to dissolve. This is explained in detail in document D2. The voltage pulses with amplitude Uc serve to clean the electrode tool 3 in a manner as disclosed with reference to FIG. 17. The value Uc is preferably larger than the value Un, the last one chosen such as not to dissolve the electrode tool 3. The disadvantage of the higher value of Uc being thus dissolution of the electrode tool 3. This may be prevented by employing non dissolving electrode materials such as platinum or by employing a passivating electrolyte such as sodium nitrate in combination with a chromium-steel electrode. With this last choice of electrolyte and electrode material, the value Uc should not be larger then 3.6 V as otherwise the passivating functioning is stopped and the electrode will start to dissolve. Preferably the value is kept below 2 V. How many and with which length the cleaning pulses have to be applied, will have to be determined by trial and error. For instance after every 20 s machining applying one cleaning pulse of 1 s. Curve III shows the combined current Ig passing the gap 6 as a result of the applied current and voltage pulses. The current pulse of normal polarity has an amplitude Ig1, the voltage pulses of opposite polarity induce a maximum current of Ig2 and Ig3. Curve IV shows the measured voltage Um across the gap 6. The voltage pulses of opposite polarity having amplitudes of Um1 and Um2. The voltage Um measured immediately after termination of the current pulse while no other pulses are being applied, is called the polarization voltage Upol, eventually decreasing to zero.

Thus an advantageous method is obtained by choosing as a process control parameter the application of such an electrode tool cleaning pulse, if the evaluation of the process condition such as apparent from the spectral content of the measured voltage Um, indicates pollution of the electrode tool. Especially in case of electrolyte which has been used for a long time, a deposition of dissolved metal ions of the dissolved workpiece may occur as black layer along the total area of the electrode tool. This is called plating and may effect the geometrical dimensions. Another contamination is deposition of a hydroxide layer near the electrolyte outflow opening within the gap. This does not only effect the geometrical dimension but also the flow rate of the electrolyte. It is noted that such an electrode tool cleaning pulse may also applied in advance, at predetermined instants.

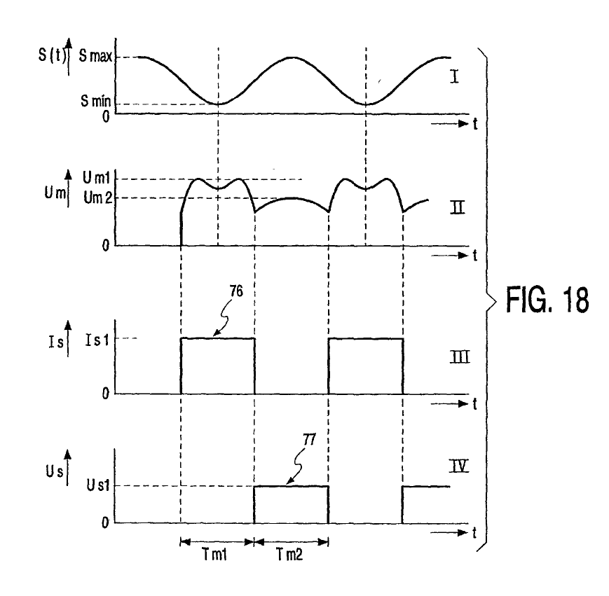

FIG. 18 illustrates a next advantageous embodiment, based on an oscillatory movement as indicated by curve I in FIG. 18. Machining current pulses 76 are being applied as indicated by curve III. An advantageous process control parameter is obtained by applying so-called passivation pulses 77 of the same polarity but with smaller amplitude. These pulses are being applied when the gape size is large, so as to avoid undesired distortions of the shape. As disclosed in more detail in document D3, in the list of referred documents that can be found at the end of this description, such passivation pulses improve the machining copying accuracy as a passivation layer is formed on those surface of the workpiece 1 which is not or less to be machined. Evaluation of the process conditions by the spectral content may induce a change from a relatively low precision machining process to a relatively high precision machining process and vice versa. This may also be induced after having machined a predetermined amount of material out of a total amount to be machined, for instance 80 μm out of a total of 120 μm.

It is remarked, that although the several current and voltage sources are shown to be incorporated in one unit, in practice the sources may be placed apart and connected by suitable connection means to the electrochemical process unit 10 and the control unit 12. Further, one or more sources may be missing or one ore more sources may be added, in dependence of the method according to the invention.

Further is remarked to a transition from one type of process of electrochemically machining to another type, may be performed either automatically or manually. Manually changing may imply the changing of the electrochemical process unit 10, of the power supply unit 11 or of a current or voltage source.

Although the invention has been described with reference to preferred embodiments thereof, it is to be understood that these are not limitative examples. Thus, various modifications may become apparent to those skilled in the art, without departing from the scope of the invention, as defined by the claims. The invention can be implemented by means of both hardware and software, and that several “means” may be represented by the same item of hardware. Further, the invention lies in each and every novel feature or combination of features. It is also remarked that the word ‘comprising’ does not exclude the presence of other elements or steps than those listed in a claim. Any reference signs do not limit the scope of the claims.

### LIST OF REFERRED DOCUMENTS

(D1) International Patent Publication WO 99/34949, in the name of applicant, (PHN 16713)

(D2) International Patent Publication WO 97/03781, in the name of applicant, (PHN 15754)

(D3) International Patent Publication WO 99/51382, in the name of applicant, (PHN 16835)

1. A method of controlling a process of electrochemically machining an electrically conductive workpiece the process comprising
applying an electric current between the workpiece and an electrically conductive electrode while electrolyte is supplied between the workpiece and the electrode, the method of controlling comprising
measuring a voltage induced by the electric current and
adapting at least one process control parameter in response to the measured voltage, characterized by,
determining information relating to the spectral composition of the measured voltage within a predetermined measuring period during the process of electrochemically machining and
adapting the at least one process control parameter in accordance with said information.

2. A method according to claim 1, wherein said information comprises at least one amplitude representative of at least one frequency component or at least one range of frequency components of the measured voltage.

3. A method according to claim 2 wherein said information comprises the amplitude representative of at least an harmonic frequency of the waveform constituted by the measured voltage within the predetermined measuring period.

4. A method according claim 3, wherein the method comprises expanding the wave form within the predetermined measuring period in a Fourier series of trigonometric functions and wherein said amplitudes correspond to the Fourier coefficients Ck of said series.

5. A method according to claim 4, wherein the method comprises determining the sign of the Fourier coefficients Ck of a first number of harmonics of said Fourier series and assigning a specific process condition to at least one specific combination of Fourier coefficients indicating absence or presence of a corresponding harmonic and in case of presence, the relative sign of the corresponding harmonic.

6. A method according to claim 5, wherein the method comprises assigning a first process condition of relatively low current density to the absence of a first consecutive number of Fourier coefficients Ck.

7. A method according to claim 5, wherein the method comprises assigning a second process condition of presence of gas-filled cavities in the electrolyte to the presence of second number of consecutive Fourier coefficients Ck with mutually alternating signs.

8. A method according to claim 5, wherein the method comprises assigning a third process condition of relatively high current density to the presence of a third number of consecutive Fourier coefficients Ck with mutually equal signs.

9. A method according to claim 2, wherein said information comprises amplitudes representative of a range of frequency components greater than a predetermined frequency and the adapting of the at least one process control parameter in case of a substantially change of the amplitudes within the predetermined measuring period.

10. A method according to claim 9, wherein said information comprises a running average of said amplitudes across a predetermined time interval.

11. A method according to claim 1, wherein the at least one process control parameter involves changing applying the electric current continuously to applying the electric current intermittently.

12. A method according to claim 11, wherein
during applying the electric current continuously, the electrode and the workpiece are moved relatively to each other with a substantially constant speed and
during applying the electric current intermittently, the electrode and workpiece are moved relatively to each other in an oscillatory manner or in a repeated manner superposed on a linear movement with applying the current at or near the instant of smallest mutual distance induced by the oscillatory or repeated distance. between the workpiece and the electrode

13. A method according to claim 12, wherein a sequence of intermittently applied electric current pulses is applied when the relative distance between the workpiece and the electrode is small during the relatively oscillatory or repeated movement.

14. A method according to claim 1, wherein the applying of electric current comprises applying electric current pulses of a normal polarity intermittently in pulse like periods, the at least one process control parameter controls applying additionally one or more electric current pulses of an opposite polarity.

15. A method according to claim 1, wherein the applying of electric current comprises applying electric current pulses of a normal polarity intermittently in pulse like periods, the at least one process control parameter controls applying additionally electric current passivation pulses of the same polarity but with an voltage having an amplitude which is inadequate to dissolve the workpiece and a passivation film on the workpiece.

16. A method according to claim 1, wherein the at least one process control parameter controls the application of an electrode cleaning electric current intermittently in one or more pulse like periods with an opposite polarity causing the electrode being cleaned of deposited waste.

17. A method according to claim 16, wherein the electrode and workpiece are moved relatively to each other in a repeated movement, the applying of electric current comprising applying electric pulses intermittently when the distance between the workpiece and the electrode is relatively small, the corresponding position of electrode and workpiece being determined by first bringing the workpiece and the electrode in contact with each other and applying a measurement current in stead of a machining current to determine a contact, the at least one process control parameter controls the applying of one or more electrode cleaning pulses prior to bringing the workpiece and electrode in contact.

18. A method according to claim 1, wherein the electrode and workpiece are moved relatively to each other in a repeated movement, the application of electric current comprising applying electric pulses intermittently in pulse like periods when the distance between the workpiece and the electrode is relatively small, the at least one process control parameter controls changing the duration of the pulse like period.

19. A method according to claim 1, wherein the duration of the pulse like period is reduced to a value smaller then a seeding time required for formation of gas bubbles in the electrolyte.

20. A method according to claim 19, wherein the pulse period is reduced to a value between 10 to 100 microseconds.

21. A method according to claim 20, wherein the corresponding pulse forefront has a value between 100 and 1000 nanoseconds.

22. A method according to claim 19, wherein sequences of intermittently applied electric current pulses are being applied, the pauses between the pulses in a sequence having a value larger than a escape time required for escaping gas bubbles that has been formed in the electrolyte.

23. A method according to claim 22, with a ratio of pause/pulse duration between 2 and 10.

24. A method according to claim 9, wherein the at least one process control parameter controls a fast interrupt of the applied electric current.

25. A method according to claim 1, wherein the electrode and workpiece are moved relatively to each other in an oscillatory movement, the electric current being supplied intermittently in pulse like periods when the distance between the workpiece and the electrode is relatively small, the at least one process control parameter comprises the relative phase shift between the oscillatory movement and the start of applying the electric current each oscillatory movement.

26. A method according to claim 1, wherein the electrode and wordpiece are moved relatively to each other in an oscillatory movement, the electric current being supplied intermittently in pulse like periods when the distance between the workpiece and the electrode is relatively small, the at least one process control parameter comprises an electrolyte pressure.

27. A method according to claim 1, wherein the electrode and workpiece are moved relatively to each other in an oscillatory movement, the electric current being supplied intermittently in pulse like periods when the distance between the workpiece and the electrode is relatively small, the at least one process control parameter comprises the relative machining speed the workpiece and electrode are being moved relatively to each other.

28. A method according to claim 1, wherein the process of electrochemically machining comprises applying the electric current in pulse like periods, wherein the predetermined measuring period substantially corresponds to the duration of a pulse.

29. A method according to claim 1, wherein the process of electrochemically machining comprises applying the electric current substantially continuously during a first time duration, wherein the predetermined measuring period is a fraction of said first time duration, such that variations in process conditions may be measured within the measuring period.

30. A method of electrochemically machining an electrically conductive workpiece, the method comprising
applying an electric current between the workpiece and an electrically conductive electrode while electrolyte is supplied between the workpiece and the electrode,
the method comprises
a material removing step wherein the electric current is supplied continuously while the workpiece and the electrode are moved relatively to each other with a substantially constant speed and
a workpiece shaping step wherein the electric current is supplied intermittently in pulse like periods while the workpiece and the electrode are moved relatively to each other in a oscillatory or repeated movement, the electric current being supplied when the distance between the workpiece and the electrode is relatively small.

31. A method according to claim 30, wherein a sequence of intermittently applied electric current pulses is applied when the distance between the workpiece and the electrode is relatively small during the relatively oscillatory or repeated movement.

32. A method according to claim 31 or 30, wherein the duration of the pulse like period is reduced to a value smaller then a seeding time required for formation of gas bubbles in the electrolyte, such as for instance the formation of hydrogen gas.

33. A method according to claim 32 or 30, wherein the pulse period is reduced to a value between 10 to 100 microseconds.

34. A method according to claim 32, wherein the pauses between the pulses in a sequence have a value larger than a escape time required for escaping gas bubbles that has been formed in the electrolyte.

35. A method according to claim 34, with a ratio of pause/pulse duration between 2 and 10.

36. A method according to claim 30, wherein the workpiece shaping step comprises applying electric current pulses of a normal polarity intermittently in pulse like periods and applying additionally electric current passivation pulses of the same polarity but with a voltage having an amplitude which is inadequate to dissolve the workpiece and a passivation film on the workpiece.

37. A method according to claim 30, wherein the method comprises a workpiece finishing step comprising applying electric current pulses of a normal polarity intermittently in pulse like periods and applying additionally one or more electric current pulses of an opposite polarity.

38. A method according to claim 30, wherein the method comprises a electrode tool cleaning step comprising applying of electric current intermittently in one or more pulse like periods with an opposite polarity causing the electrode being cleaned of deposited waste.

39. An arrangement for electrochemically machining an electrically conductive workpiece by applying an electric current between a workpiece and an electrically conductive electrode while electrolyte is supplied between the workpiece and the electrode, the arrangement comprises:
an electrically conductive electrode (3);
means for positioning (4,5) the electrode and the workpiece (1) in a spatial relationship so as to maintain a gap between the electrode (3) and the workpiece (1);
means for supplying (7) the electrolyte into the gap;
an electric power supply source (11), which is electrically connectable to the electrode (3) and the workpiece (1) to apply an electric current between the workpiece (1) and the electrode (3),
characterized in that, the arrangement further comprises
voltage measurement means (17,22) electrically connected with the electrode (3) and the workpiece (1) or with an impedance circuitry in a power supply line between the power supply source (11) and the workpiece (1) or the electrode (3);
process adjusting means (16,24,27,30) for adjusting at least one process control parameter of the electrochemically machining process;
controlling means (12) connected with the voltage measurement means (17,22) and the process adjusting means (16,24,27,30)
the controlling means (12) being provided with analyzing means (48) for determining information (Ck, Ac) relating to the spectral composition of a measured voltage (Um) within a predetermined period (Tm, Tm′) during the process of electrochemically machining and
the controlling means (12) being adapted to adjust the at least one process control parameter signal (Pi, S1, S2, SEL1, SEL2, CI1, CU1, . . . ) in accordance with said spectral information.

40. Arrangement according to claim 39, characterized in that,
the analyzing means (48) are adapted to generate at least one spectral signal representative of an amplitude of at least one frequency component or at least one range of frequency components of the measured voltage.

41. Arrangement according to claim 40, characterized in that,
the analyzing means (48) comprises harmonic detecting means (53) for generating a spectral signal (Ck) representative of at least an harmonic frequency of the waveform constituted by the measured voltage (Um) within the predetermined measuring period (Tm).

42. Arrangement according to claim 41, characterized in that,
the analyzing means (48) comprises waveform expanding means (53) expanding the waveform within the predetermined measuring period (Tm, Tm′) in a Fourier series and for
generating spectral signals representative of the amplitudes of Fourier coefficients Ck of the Fourier series.

43. Arrangement according to claim 42, characterized in that,
the waveform expanding means (53) comprises sign determining means to determine the sign of the spectral signals representing a first number of harmonics of said Fourier series,
the controlling means (12) comprises assigning means (54) to generate a specific process condition signal in case of a specific combination of signs of the spectral signals Ck representing the first number of harmonics are being supplied to the controlling means (49)

44. Arrangement according to claim 43, characterized in that,
the assigning means (54) are adapted to generate a first process condition signal (T) indicative of a relatively low current density in case if the spectral signals indicate the absence of a first number of Fourier coefficients Ck.

45. Arrangement according to claim 43, characterized in that,
the assigning means (54) are adapted to generate a second process condition signal (T) indicative of the presence of gas-filled cavities in the electrolyte in case if the spectral signals indicate a second number of consecutive Fourier coefficients Ck with mutually alternating signs.

46. Arrangement according to claim 43, characterized in that,
the assigning means (54) are adapted to generate a third process condition signal (T) indicative of the presence of a relatively high current density in case of a third number of consecutive Fourier coefficients Ck with mutually equal signs.

47. Arrangement according to claim 40, characterized in that,
the analyzing means (48) comprises
high pass filtering means (55) for generating spectral signals representative of a range of frequency components greater than a predetermined frequency and
spectral signal change detecting means (59) for detecting a rapid change of the generated spectral signals within the predetermined measuring interval (Tm) and supplying a corresponding spectral signal change signal (Ac) to the controlling means,
the controlling means (12) being adapted to adjust the at least one process control parameter signal in case of the spectral signal change signal (Ac) being supplied.

48. Arrangement according to claim 47, characterized in that,
the analyzing means (48) comprise averaging means (58) for averaging the amplitudes of the spectral signals generated across a predetermined time interval (Tm).

49. Arrangement according to claim 39, characterized in that,
the electric power supply source (11) comprises a constant current or a constant voltage source (15,23) for applying the electric current continuously,
a pulsed current or pulsed voltage source (26,29) for applying the electric current intermittently and
switching means (19,25,28,31) to switch between the respective sources.

50. Arrangement according to claim 49, characterized in that,
the means for positioning comprises:
first positioning means (4) for moving the electrode (3) and the workpiece (1) relatively to each other with a substantially constant speed and
second positioning means (5) for moving the electrode (3) and the workpiece (1) relatively to each other in oscillatory or repeated manner.

51. Arrangement according to claim 50, characterized in that, the pulsed current source (26,29) is adapted to generate a sequence of intermittently applied pulses when the relative distance between the workpiece (1) and the electrode (3) is small during the relatively oscillatory or repeated movement.

52. Arrangement according to claim 39, wherein the pulsed current source (26,29) is adapted to apply electric current pulses of a normal polarity intermittently in pulse like periods, characterized in that,
the pulsed current source (26,29) is further adapted to apply additionally one or more current pulses of an opposite polarity in response to at least one process control parameter signal (SEL1, SEL2, CI1, CU1 . . . )

53. Arrangement according to claim 39, wherein the pulsed current source (26,29) is adapted to apply electric current pulses of a normal polarity intermittently in pulse like periods, characterized in that,
the pulsed current source (26,29) is further adapted to apply additionally electric passivation pulses of the same polarity but with an voltage having an amplitude which is inadequate to dissolve the workpiece (1) and a passivation film on the workpiece (1) in response to at least one process control parameter signal (SEL1, SEL2, CI1, CU1 . . . ).

54. Arrangement according to claim 39, wherein the pulsed current source (26,29) is adapted to apply an electrode cleaning electric current intermittently in one or more pulse like periods with an opposite polarity causing the electrode (3) being cleaned of deposited waste in response to at least one process control parameter signal(SEL1, SEL2, CI1, CU1 . . . ).

55. Arrangement according to claim 54, wherein the positioning means (4,5) are adapted to move the electrode (3) and the workpiece (1) to each other in a repeated movement, the pulsed current source (26,29) is adapted to apply electric current pulses intermittently when the distance between the workpiece (1) and the electrode (3) is relatively small, the control unit (12) is adapted to determine the corresponding position of electrode (3) and workpiece (1) by first bringing the workpiece (1) and the electrode (3) in connection with each other and applying a measurement current in stead of a machining current to determine a connection, characterized in that, the pulsed current source (26,29) is adapted to apply one or more electrode cleaning pulses prior to bringing the workpiece (1) and electrode (3) in connection.

56. Arrangement according to claim 39, wherein the positioning means (4,5) are adapted to move the electrode (3) and the workpiece (1) relatively to each other in a repeated movement, the pulsed current source (26,29) is adapted to apply electric pulses intermittently in pulse like periods when the distance between the workpiece (1) and the electrode (3) is relatively small, characterized in that, the pulsed current source (26,29) is adapted to change the duration of the pulse like period in response to the at least one process control parameter signal.

57. Arrangement according to claim 56, wherein the pulsed current source (26,29) is adapted to apply electric pulses with a duration of the pulse like period reduced to a value smaller then a seeding time required for formation of gas bubbles in the electrolyte, such as for instance the formation of hydrogen gas.

58. Arrangement according to claim 57, wherein the pulse period is reduced to a value between 10 to 100 microseconds.

59. Arrangement according to claim 58, wherein the corresponding pulse forefront period has a value between 100 and 1000 nanoseconds.

60. Arrangement according to claim 57, wherein the pulsed current source (26,29) is adapted to generate sequences of intermittently applied electric current pulses, the pauses between the pulses in a sequence having a value larger than a escape time required for escaping gas bubbles that has been formed in the electrolyte.

61. Arrangement according to claim 60, with a ratio of pause/pulse duration between 2 and 10.

62. Arrangement according to claim 33, wherein the electric power supply source (11) is adapted to interrupt the supply of electric current fast in response to the at least one process control parameter signal.

63. Arrangement according to claim 39, wherein the positioning means (4,5) are adapted to move the electrode (3) and the workpiece (1) relatively to each other in an oscillatory movement, the pulsed current source (26,29) is adapted to apply electric pulses intermittently in pulse like periods when the distance between the workpiece (1) and the electrode (3) is relatively small, characterized in that, the controlling means (12) are adapted to change the relative phase shift (φ) between the oscillatory movement and the start of applying the electric current each oscillatory movement in response to the at least one process control parameter signal.

64. Arrangement according to claim 39, wherein the positioning means (4,5) are adapted to move the electrode (3) and the workpiece (1) relatively to each other in an oscillatory movement, the pulsed current source (26,29) is adapted to apply electric pulses intermittently in pulse like periods when the distance between the workpiece (1) and the electrode (3) is relatively small, characterized in that, the controlling means (12) are adapted to change the electrolyte pressure (Pel) in response to the at least one process control parameter signal.

65. Arrangement according to claim 39, wherein the positioning means (4,5) are adapted to move the electrode (3) and the workpiece(1) relatively to each other in an oscillatory movement, the pulsed current source (26,29) is adapted to apply electric pulses intermittently in pulse like periods when the distance between the workpiece (1) and the electrode (3) is relatively small, characterized in that, the controlling means (12) are adapted to change the relative machining speed the workpiece (1) and the electrode (3) are moved to each other in response to the at least one process control parameter signal.

66. Arrangement according to claim 39, wherein the electric power supply source (11) is adapted to apply electric current pulses in pulse like periods, characterized in that, the predetermined measurement period (Tm, Tm′) substantially corresponds to the duration of a pulse.

67. Arrangement according to claim 39, wherein the electric power source (11) is adapted to apply the electric current substantially continuously during a first time duration, characterized in that, the predetermined measurement period (Tm, Tm′) is a fraction of said first time duration, such that variation in process conditions may be measured within the measuring period (Tm, Tm′).

68. An arrangement for electrochemically machining an electrically conductive workpiece by applying an electric current between a workpiece and an electrically conductive electrode while electrolyte is supplied between the workpiece and the electrode, the arrangement comprises:
an electrically conductive electrode (3);
means for positioning (4,5) the electrode and the workpiece (1) in a spatial relationship so as to maintain a gap between the electrode (3) and the workpiece (1);
means for supplying (7) the electrolyte into the gap;
an electric power supply source (11), which is electrically connectable to the electrode (3) and the workpiece (1) to apply an electric current between the workpiece (1) and the electrode (3),
controlling means (12) connected to the means for positioning (4,5) and the electric power supply source (11),
characterized in that,
the controlling means (12) are adapted to operate in a material removing operation mode or in a workpiece shaping operation mode,
the means for positioning (4,5) are adapted to move the electrode (3) and the workpiece (1) relatively to each other with a substantially constant speed in the material removing operation mode and in an oscillatory or repeated movement in the workpiece shaping operation mode,
the electric power supply source (11) is adapted to supply the current continuously in the material removing operation mode and intermittently in pulse like periods when the relative distance between the workpiece (1) and the electrode (3) is relatively small in the workpiece shaping operation mode.

69. Arrangement according to claim 68, wherein the electric power source (11) is adapted to generate a sequence of intermittently applied electric current pulses when the distance between the electrode (3) and the workpiece (1) is relatively small in the workpiece shaping operation mode.

70. Arrangement according to claim 69 or 68, wherein the pulsed current source (26,29) is adapted to apply electric pulses with a duration of the pulse like period reduced to a value smaller then a seeding time required for formation of gas bubbles in the electrolyte, such as for instance the formation of hydrogen gas.

71. Arrangement according to claim 70, wherein the pulse period is reduced to a value between 10 to 100 microseconds.

72. Arrangement according to claim 70, wherein the pulsed current source (26,29) is adapted to generate sequences of intermittently applied electric current pulses, the pauses between the pulses in a sequence having a value larger than a escape time required for escaping gas bubbles that has been formed in the electrolyte.

73. Arrangement according to claim 72, with a ratio of pause/pulse duration between 2and 10.

74. Arrangement according to claim 68, characterized in that,
the electric power supply source (11) is adapted in the workpiece shaping operation mode to apply electric current pulses of a normal polarity intermittently in pulse like periods and to apply additionally electric passivation pulses of the same polarity but with and voltage having an amplitude which is inadequate to dissolve the workpiece (1) and a passivation film on the workpiece (1)

75. Arrangement according to claim 68, characterized in that,
the controlling means (12) are adapted to operate in a workpiece finishing operation mode and
the electric power supply source (11) is adapted in the workpiece shaping operation mode to apply electric current pulses of a normal polarity intermittently in pulse like periods and to apply additionally one or more electric current pulses of an opposite polarity.

76. Arrangement according to claim 68, characterized in that,
the controlling means (12) are adapted to operate in an electrode tool cleaning operation mode and
the electric power supply source (11) is adapted in the electrode tool cleaning operation mode to apply electric current pulses intermittently in one or more pulse like periods with an opposite polarity causing the electrode being cleaned of deposited waste.

77. A method of electrochemically machining an electrically conductive workpiece by applying an electric current between the workpiece and an electrically conductive electrode while electrolyte is supplied between the workpiece and the electrode, the method comprising:
a material removing step wherein the electric current is supplied continuously while the workpiece and the electrode are moved relatively to each other with a substantially constant speed,
a workpiece shaping step wherein the electric current is supplied intermittently in pulse like periods while the workpiece and the electrode are moved relatively to each other in a oscillatory or repeated movement, the electric current being supplied when the distance between the workpiece and the electrode is relatively small, the method further comprising:
measuring a voltage induced by the electric current,
determining information relating to the spectral composition of the measured voltage within a predetermined measuring period during the process of electrochemically machining and
adapting at least one process control parameter in accordance with said information.
